(19) United States
(12) Patent Application Publication
(10) Pub. No.: US 2008/0081696 A1
(43) Pub. Date: Apr. 3, 2008

(54) GAME FOR MOBILE STATION USERS

(75) Inventor: Charles P. Schultz, North Miami Beach, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/537,398

(22) Filed: Sep. 29, 2006

(51) Int. Cl. G06F 19/00

(52) U.S. Cl. 463/41

(57) ABSTRACT

A method (200) to support gaming on mobile stations (110, 112, 114, 116, 118). The method can include selecting an active player (120) from a plurality of mobile station users (120, 122, 124, 126, 128). Further, unit information (132, 134, 136, 138) can be collected for a plurality of mobile station users (122, 124, 126, 128) not selected as the active player. A user list (140) to be presented to the active player can be generated. The user list can include user names for the users not selected as the active player. The method also can include generating an offer to be presented to the active player. The offer can be based on the collected unit information. In addition, the method can include initiating a prompt to be presented to the active player to choose between accepting the offer and removing a user from the user list.

### BACKGROUND OF THE INVENTION

1. Field of the Invention

The present invention generally relates to electronic games and, more particularly, to electronic games which may be played on a mobile station.

2. Background of the Invention

The use of mobile stations has grown to an extent that such devices are now ubiquitous throughout most of the industrialized world. Just as their use has grown, so too has the functionality of mobile stations. Indeed, mobile stations now can be used not only for voice communications, but also to perform a number of other tasks. For example, mobile stations can be used to take photographs, capture and stream video, browse the Internet, send and receive instant messages and e-mail, and play games.

Mobile station users often tire of games currently provided on mobile stations, with a typical comment being that such games lack thrill and excitement. Accordingly, there is a high demand for games that are exciting to mobile station users and which can capture their interest for an extended period.

### SUMMARY OF THE INVENTION

The present invention relates to a method to support gaming on mobile stations. The method can include selecting an active player from a plurality of mobile station users. Further, unit information can be collected for a plurality of mobile station users not selected as the active player. The unit information can represent account information for the respective users, for example values tracked by the accounts of respective users. A user list to be presented to the active player can be generated. The user list can include user names for the users not selected as the active player. The method also can include generating an offer to be presented to the active player. The offer can be based on the collected unit information.

In addition, the method can include initiating a prompt to be presented to the active player to choose between accepting the offer and removing a user from the user list. Initiating the prompt can include initiating a countdown timer to be presented to the active player, the countdown timer indicating an amount of time remaining for the active player to choose between accepting the offer and removing the user from the user list.

A unit list to be presented to the active player can be generated. The unit list can include the collected unit information. Generating the unit list can include ordering the unit information in the unit list in a manner such that an order of the unit information does not match an order of users associated with the unit information on the user list. Further, credits can be added to an account of the active player in response to the active player accepting the offer.

A prompt to the active player to select the user can be initiated. An active player selection of a user can be received in response to the active player choosing to remove a user from the user list. The selected user can be removed from the user list. In addition, unit information associated with the selected user can be removed from the unit list. In such an arrangement, generating the offer can include determining an average of unit information remaining on the unit list after the unit information associated with the selected user has been removed.

The method also can include prompting the active player to select a second player from the plurality of mobile station users, the second player not being available for removal from the user list. Credits can be added to an account of the active player and to an account of the second player in response to the active player accepting the offer.

The present invention also relates to a mobile station. The mobile station can include a user interface that presents a user list to an active player who is selected from a plurality of mobile station users. The user list can include user names for users not selected as the active player. The user interface also can present an offer to the active player. The offer can be based on collected unit information associated with the users that were not selected as the active player. Further, the user interface can present a prompt to the active player to choose between accepting an offer that is based on the collected unit information or removing a user from the user list.

The user interface also can present a unit list to the active player, the unit list can include the collected unit information. The unit list can present the unit information in a manner such that an order of the unit information does not match an order of users associated with the unit information on the user list. Further, the user interface can receive an active player selection of a user in response to the active player choosing to remove a user from the user list.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 is a flowchart that is useful for understanding the present invention;

FIG. 3 depicts a block diagram of a mobile station that is useful for understanding the present invention;

FIG. 4 depicts a user interface screen that is useful for understanding the present invention; and

FIG. 5 depicts a block diagram of a server that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a game that can be played among a plurality of mobile station users. An active player can be selected from among the mobile station users. The active player can be presented a listing of the other users and a listing of unit information associated with the other users, such as the other users' unused mobile station credits. Notably, the unit information can be presented in an order that is different than the order in which the other users are presented. Accordingly, the active player will not know which unit information corresponds to which users.

The active player then can begin selecting users to remove from the user list. Each time a user is removed, that user's unit information can be removed from the unit list. An average value of the remaining unit information then can be determined and the player can be presented an offer to end the present round of the game. The offer can comprise the average value, or a portion of the average value, or any other desired value. The player can either choose to accept the offer or choose to continue playing. If the player chooses to continue playing, the player can select a next user to remove from the user list and the process can continue. If the player never accepts an offer during the game, the player can win a value that is based on the remaining user's unit information. Regardless of whether the player accepts an offer or plays until the last user remains, the value won by the player can be applied to an account of the player, for instance as credits for additional air-time and/or other products/services provided by the player's communication services provider. Of course, it is anticipated that the game play can be changed to implement various arrangements, and such arrangements are within the scope of the present invention.

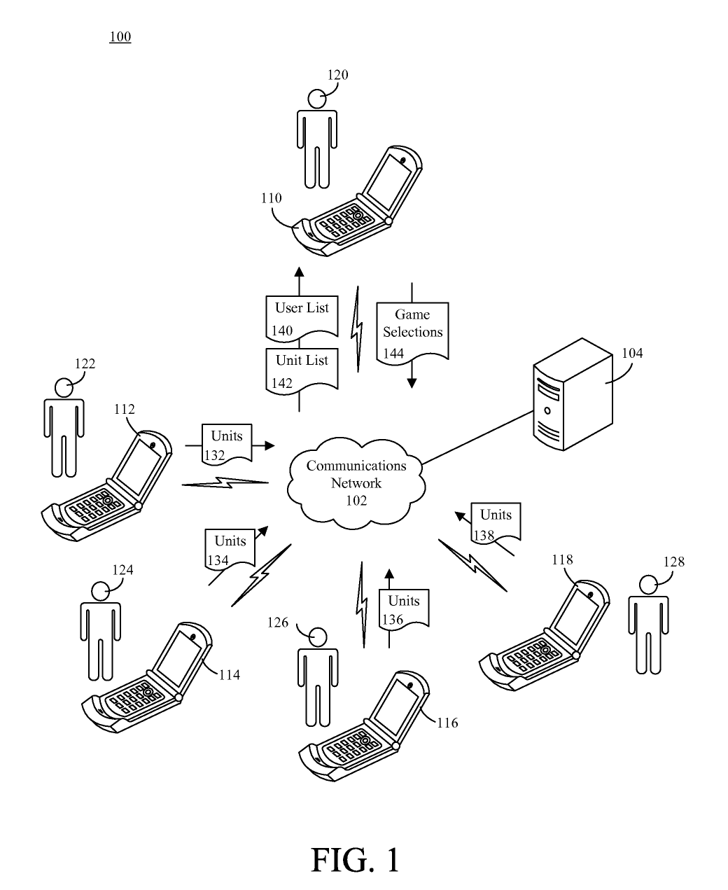

FIG. 1 depicts a communications system 100 that is useful for understanding the present invention. The communications system 100 can include a communications network 102, which can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network can include wired and/or wireless communication links.

A server 104 also can be provided in the communications system 100. The server 104 can be a mobile switching center (MSC), a base station controller (BSC), a base transceiver station (BTS), a network server, a web server, or any other processing device which may process communication signals communicated to and/or from mobile stations 110, 112, 114, 116, 118 that are communicatively linked to the communications network 102.

The mobile stations 110-118 can be mobile communication devices, such as mobile computers, personal digital assistants (PDAs), mobile telephones, mobile radios, mobile gaming devices, or any other mobile electronic devices that may communicate via the communications network 102. Each of the mobile stations can be associated with an account of a respective user 120, 122, 124, 126, 128. The accounts can track user account information, such as credits or unused time available in communication service plans, time used over a specified period, excess time used beyond a threshold value, or any other desired values.

In operation, each of the users 120-128 can select an option on their respective mobile stations 110-118 to enter game play. For example, the users 120-128 can select to play a game from a menu of available gaming options. The users 120-128 can be randomly grouped with each other or can be members of a particular group. For instance, at some point prior to commencement of the game, one of the users 120-128 can create a gaming group and can invite other users to join the gaming group.

In another arrangement, the users 120-128 for a particular game can be selected such that the users are not likely to be known to one another. For example, when the users 120-128 are selected to play the game, their respective contact lists and/or recent call lists can be examined. The contact lists can be contained on their respective mobile stations 110-118, or contained externally with respect to the mobile stations 110-118. For example, the contact lists can be contained on a server, a personal computer, or any other suitable device and associated with the respective users 120-128. Moreover, the contact lists can be maintained by any program suitable for maintaining contact lists.

If the user 124 is contained in the contact list or the recent call list of the user 122, the user 124 can be excluded from the present game and selected for play in another instance of the game. Further, the users 120-128 also can be selected in a manner to insure that the users 120-128 are not located proximate to one another. For example, positioning systems associated with the mobile stations 110-118 can provide positioning information to the server 104, or the server 104 can determine an approximate position of the mobile stations 110-118 based on the respective locations of base transceiver stations and/or repeaters with which the mobile stations 110-118 have established communication sessions. If the user 124 is proximately located to the user 122, the user 124 can be excluded from the present game and selected for play in another instance of the game. Still, the users 120-128 can be selected for game play in any other suitable manner and the invention is not limited in this regard.

A user, for instance the user 120, can be selected as an active player (hereinafter “player”). The user 120 can be randomly selected or selected based on defined conditions. For example, a user who pays the highest average monthly service fees can be selected.

Unit information 132, 134, 136, 138 can be communicated from each of the respective mobile stations 112-118 to the active player's mobile station 110. The unit information 132-138 can represent account information for the respective users 122-128, for example values tracked by the accounts of respective users 122-128. For instance, each unit can represent an available minute of air time. The unit information 132-138 can be communicated to the server 104, which can compile the unit information into a unit list 142. The unit information 132-138 can be represented in the unit list 142 as numbers that correlate to the total number of units associated with a corresponding user 122-128.

In another arrangement, rather than receiving the unit information 132-138 from the mobile stations 112-118, the server 104 can access the accounts of the users 122-128 to retrieve such information. The account information can be located on the server 104, or on another device communicatively linked to the server. For example, the account information can be stored in a database to which the server 104 is communicatively linked.

The server 104 can compile user names representing the users 122-128 into a user list 140. The order in which the user names are presented in the user list 140 need not match the order in which the unit information 132-138 is presented in the unit list 142. For example, the user name of the user 122 may be presented first in the user list 140, while the unit information 132 may be presented third in the unit list 142. Accordingly, the active player 120 will not know which unit information 132-138 corresponds to which user 122-128. During game play, the player 120 can select user names to remove from the user list 140 and communicate such game selections 144 to the server 104.

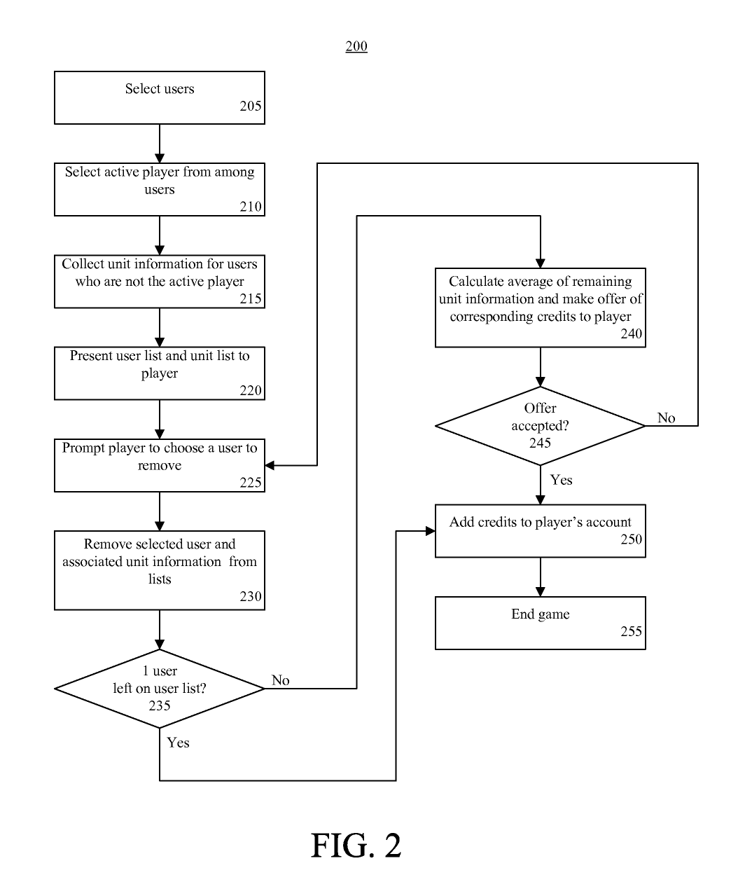

FIG. 2 is a flowchart presenting a method 200 that is useful for understanding the game play. Beginning at step 205, users to participate in the game can be selected, as previously described, and at step 210 an active player can be selected. At step 215 the server can collect the unit information associated with the users who are not the active player. As noted, the unit information can be communicated from the mobile stations to the server, or the server can retrieve such information from another location, such as a database.

Proceeding to step 220, the server then can communicate the user list and unit list to the active player's mobile station, and such lists can be presented to the player. At step 225 the player can be prompted to choose a user to remove from the user list, and the player selection can be communicated to the server. In one arrangement, the player can be provided a limited amount of time to select such a user. In addition, a countdown timer can be initiated and presented to the player. The amount of time provided to the player to make a user selection can decrease each time the process returns to step 225 as game play progresses. If the player fails to select a user to remove from the user list within the allocated time, a user can be automatically selected at random, or the game can immediately end.

At step 230 the server then can remove the selected user from the user list, and remove the unit information associated with the selected user from the unit list. In one arrangement, each time a user and corresponding unit information are removed from the respective user and unit lists, the server can re-arrange the order in which the entries in the user list and unit list are presented. The server then can communicate updated user and unit lists to the player's mobile station. In addition, the server also can communicate updated user and unit lists to other game participants, for instance the selected users.

Referring to decision box 235, if only one user is left on the user list, the process can proceed to step 250 and credits can be added to the player's account, for example his account with a communication services provider. The credits can correspond to the number of units associated with the user remaining on the user list, or percentage of such number of units. In another arrangement, points can be awarded to the player. Such points may be, or may not be, exchanged for products or services. At step 255 the game can end.

Referring again to decision box 235, while there remains more than one user on the user list, at step 240 the server can calculate an average value for the unit information associated with such users. For example, the server can compute a mean, median, mode, or any other desired average value. The server then can make an offer to the player. For example, the server can offer to the player credits that correspond to the average value of the remaining units, or a percentage of such average value. Referring to decision box 245, if the player accepts the offer, at step 250 the credits can be added to the player's account and at step 255 the game can end. If, however, the player does not accept the offer, the process can return to step 225 and the player can be prompted to choose another user to remove from the user list. The process then can continue until the game ends.

In one aspect of the inventive arrangements, the player can be provided a limited amount of time to accept or reject the offer. In addition, a countdown timer can be initiated and presented to the player. The amount of time provided to the player to accept or reject the offer can decrease each time the process returns to step 240 as game play progresses. If the player fails to accept or reject the offer within the allocated time, such a decision can be automatically selected by the system, or the game can immediately end.

In an alternate arrangement, after step 210, the active player can be prompted to select a user (hereinafter “second player”) who may not be removed from the user list. At step 235, rather than determining whether a single user remains on the user list, a determination can be made whether there remains only one user in addition to the second player. In this arrangement, at step 250, the credits can be added both to the active player's account and the second player's account. The credits can be evenly split between both players, or a percentage can be allocated to each of the players.

In yet another arrangement, each of the users selected in step 205 can be selected as the active player 210 in their own game thread, and all other selected users can be added to the user list at step 215. In such an arrangement, at step 250, the credits (or points) won by each player can be compared to each of the other players, and the player with the most credits or points can be selected as a winner. The credits then can be transferred exclusively to the winner's account, or split among those with the highest scores. Of course, the percentage of credits allocated to each of such players can be determined by their ranking in the game.

In another aspect of the invention, users and/or players can be charged for the benefit of participating in game play. For example, credits can be deducted from their user accounts. The credits that are deducted can be a set amount, or can vary depending on a player's performance in the game. For example, a base entry fee can be offset by any credits won during game play.

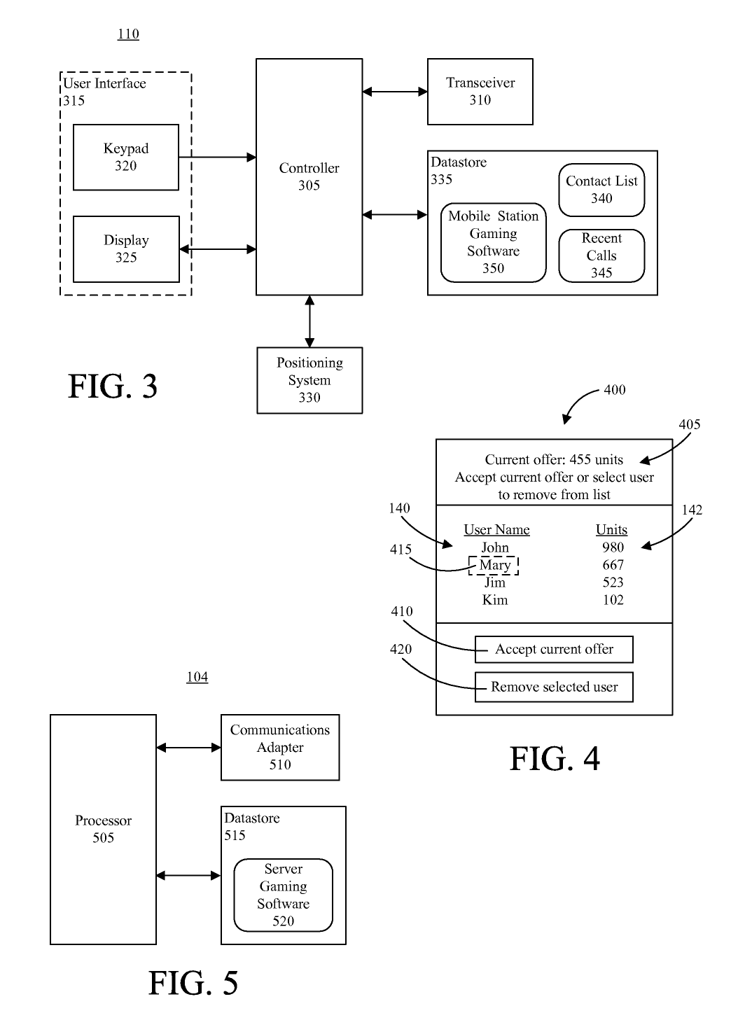

FIG. 3 depicts a block diagram of the mobile station 110. The mobile station 110 can include a controller 305. The controller 305 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The mobile station 110 also can include a transceiver 310 that is used by the mobile station 110 to communicate with communications network. The transceiver 310 can communicate data via IEEE 802 wireless communications, including 802.11 and 802.16 (WiMax), WPA, WPA2, GSM, TDMA, CDMA, WCDMA, direct wireless communication, TCP/IP, or any other suitable form of wireless communications.

A user interface 315 also may be provided with the mobile station 110. The user interface 315 can include a keypad 320, a display 325, buttons, sensors, input and output audio transducers, and/or any other devices which may receive user inputs or present information to a user. A positioning system 330 also can be provided. The positioning system 330 can include global positioning satellite (GPS) receiver, a receiver that detects local positioning signals, a receiver that detects a local transponder, and/or any other suitable position identification system or device. Positioning information generated by the positioning system 330 can be communicated to a server via the transceiver 310.

Further, the mobile station 110 can include a datastore 335. The datastore 335 can include one or more storage devices, each of which can include a magnetic storage medium, an electronic storage medium, an optical storage medium, a magneto-optical storage medium, and/or any other storage medium suitable for storing digital information. In one arrangement, the datastore 335 can be integrated into the controller 305. A contact list 340 and a recent call list 345 can be contained on the datastore 335. The contact list can comprise a listing of user contacts, as well as information associated with such contacts. The recent call list 345 can comprise a listing of calls recently received and/or recently placed by the mobile station 110.

Mobile station gaming software 350 also can be contained on the datastore 335. The mobile station gaming software 350 can be executed by the controller 305 to implement the methods and processes described herein which are allocated to the mobile station 110. For example, at run time the mobile station gaming software 350 can receive the user list and unit list, and configure such lists for presentation on the display 325. The mobile station gaming software 350 also can present prompts to the player to select users to remove from the user list, present offers to the player, process player inputs, and forward game selections to the transceiver 310 for communication to the server. Still, the mobile station gaming software 350 can perform a myriad of other functions and the invention is not limited in this regard.

FIG. 4 depicts a screen 400 of a user interface that can be presented on the display of the player's mobile station. The player can navigate the screen 400 using a keypad, buttons, a stylus, tactile inputs, voice inputs, or in any other suitable manner. In the case in which a stylus or tactile inputs are used to navigate the screen 400, the display can comprise a touch screen. In the case in which voice inputs are used to navigate the screen 400, the mobile station can include voice recognition software.

The screen 400 can include the user list 140 and the unit list 142. The user names contained in the user list 140 can comprise actual names, screen names, fake names, numbers, symbols, icons or pictures. In addition, a prompt 405 can be shown on the screen 400. As noted, the prompt 405 can ask the player to choose between accepting the current offer or removing a user from the user list 140. The player can choose to accept the current offer by selecting a button, soft key or selectable icon 410. Alternatively, the player can choose to remove a user by selecting such a user 415 and selecting a button, a soft key or a selectable icon 420 to remove the selected user.

FIG. 5 depicts a block diagram of the server 104. The server 104 can include a processor 505. The processor 505 can comprise, for example, a CPU, a DSP, an ASIC, a PLD, a plurality of discrete components that cooperate to process data, and/or any other suitable processing device.

The server 104 also can include a communications adapter 510 with which the server communicates via the communications network. The communications adapter 510 can be a wired communications adapter, for instance a network adapter or a communications port, or a wireless adapter, such as a transceiver. The communications adapter 510 can communicate data via IEEE 802 wireless communications, including 802.11 and 802.16 (WiMax), WPA, WPA2, GSM, TDMA, CDMA, WCDMA, direct wireless communication, TCP/IP, or any other suitable form of wireless and/or wired communications.

The server 104 also can include a datastore 515. The datastore 515 can include one or more storage devices, each of which can include a magnetic storage medium, an electronic storage medium, an optical storage medium, a magneto-optical storage medium, and/or any other storage medium suitable for storing digital information. In one arrangement, the datastore 515 can be integrated into the processor 505.

Server gaming software 520 can be contained on the datastore 515. The server gaming software 520 can be executed by the processor 505 to implement the methods and processes described herein which are allocated to the server 104. For example, at run time the server gaming software 520 can receive requests from users to participate in the game, select and/or reject users from game play, select at least one of the users to be an active player, receive unit information for users who are not the active players, generate the user list and the unit list, and communicate a message to the active player's mobile station prompting the active player to enter player selections. Still, the server gaming software 520 can perform a myriad of other functions and the invention is not limited in this regard.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method to support gaming on mobile stations, comprising:
selecting an active player from a plurality of mobile station users;
collecting unit information for a plurality of mobile station users not selected as the active player;
generating a user list to be presented to the active player, the user list comprising user names for the users not selected as the active player;
generating an offer to be presented to the active player, the offer based on the collected unit information; and
initiating a prompt to be presented to the active player to choose between accepting the offer and removing at least one of the users from the user list.

2. The method of claim 1, further comprising generating a unit list to be presented to the active player, the unit list comprising the collected unit information.

3. The method of claim 2, wherein generating the unit list comprises ordering the unit information in the unit list in a manner such that an order of the unit information does not match an order of users associated with the unit information on the user list.

4. The method of claim 1, further comprising adding credits to an account of the active player in response to the active player accepting the offer.

5. The method of claim 1, further comprising receiving an active player selection of a user in response to the active player choosing to remove a user from the user list.

6. The method of claim 5, further comprising initiating a prompt to the active player to select the user.

7. The method of claim 5, further comprising:
removing the selected user from the user list; and
removing unit information associated with the selected user from the unit list.

8. The method of claim 7, wherein generating the offer comprises determining an average of unit information remaining on the unit list after the unit information associated with the selected user has been removed.

9. The method of claim 1, further comprising:
prompting the active player to select a second player from the plurality of mobile station users, the second player not being available for removal from the user list.

10. The method of claim 9, further comprising adding credits to an account of the active player and to an account of the second player in response to the active player accepting the offer.

11. The method of claim 1, wherein initiating the prompt to be presented to the active player comprises initiating a countdown timer to be presented to the active player, the countdown timer indicating an amount of time remaining for the active player to choose between accepting the offer and removing the user from the user list.

12. A machine readable storage, having stored thereon a computer program having a plurality of code sections comprising:
code for selecting an active player from a plurality of mobile station users;
code for collecting unit information for a plurality of mobile station users not selected as the active player;
code for generating a user list to be presented to the active player, the user list comprising user names for the users not selected as the active player;
code for generating an offer to be presented to the active player, the offer based on the collected unit information; and
code for initiating a prompt to be presented to the active player to choose between accepting the offer and removing at least one of the users from the user list.

13. The machine readable storage of claim 12, further comprising code for generating a unit list to be presented to the active player, the unit list comprising the collected unit information.

14. The machine readable storage of claim 13, wherein the code for generating the unit list comprises code for ordering the unit information in the unit list in a manner such that an order of the unit information does not match an order of users associated with the unit information on the user list.

15. The machine readable storage of claim 12, further comprising code for adding credits to an account of the active player in response to the active player accepting the offer.

16. The machine readable storage of claim 12, further comprising:
code for initiating a prompt to the active player to select the user;
code for removing the selected user from the user list; and
code for removing unit information associated with the selected user from the unit list.

17. A mobile station, comprising:
a user interface that presents a user list to an active player who is selected from a plurality of mobile station users, the user list comprising user names for users not selected as the active player, the user interface presenting an offer to the active player, the offer based on collected unit information associated with the users that were not selected as the active player, and the user interface presenting a prompt to the active player to choose between accepting an offer that is based on the collected unit information or removing at least one of the users from the user list.

18. The mobile station of claim 17, wherein the user interface further presents a unit list to the active player, the unit list comprising the collected unit information.

19. The mobile station of claim 18, wherein the unit list presents the unit information in a manner such that an order of the unit information does not match an order of users associated with the unit information on the user list.

20. The mobile station of claim 17, wherein the user interface further receives an active player selection of a user in response to the active player choosing to remove a user from the user list.
